(19) United States
(12) Patent Application Publication
(10) Pub. No.: US 2026/0148341 A1
(43) Pub. Date: May 28, 2026

(54) HISTOGRAM-BASED CORNER SCREENING METHOD AND DEVICE

(71) Applicant: Bestechnic (Shanghai) Co., Ltd., Shanghai (CN)

(72) Inventors: Shihan WANG, Shanghai (CN); Yibo JIANG, Shanghai (CN)

(73) Assignee: Bestechnic (Shanghai) Co., Ltd., Shanghai (CN)

(21) Appl. No.: 19/433,458

(22) Filed: Dec. 26, 2025

Related U.S. Application Data
(63) Continuation of application No. PCT/CN2025/103312, filed on Jun. 25, 2025.

(30) Foreign Application Priority Data
Nov. 26, 2024 (CN) 202411705681.1

(51) Int. Cl. G06T 5/40; G06T 7/13; G06V 10/75

(52) U.S. Cl. CPC G06T 5/40; G06T 7/13; G06V 10/758; G06T 2207/20164

(57) ABSTRACT

A histogram-based corner screening method, a device, and a non-transitory computer-readable medium are provided. The method includes: determining histogram parameters of the current frame image; determining endpoints and frequencies of the groups in the histogram of the current frame image based on preset scores of corner points in the current frame image and the histogram parameters of the current frame image; determining a number of target corner points based on the number of corner points in the current frame image and the preset quantity threshold; determining a critical group where a critical corner point is located based on the number of the target corner points and the frequencies of the groups; predicting a score of the critical corner point based on endpoints of the critical group where the critical corner point is located; and determining the target corner points.

### CROSS-REFERENCE TO RELATED APPLICATIONS

This application is a continuation of International Application No. PCT/CN2025/103312, filed on Jun. 25, 2025, which claims the benefit of priority to Chinese Application No. 202411705681.1, filed on Nov. 26, 2024, both of which are incorporated herein by reference in their entireties.

### TECHNICAL FIELD

The present application relates to the field of image processing technology, and more specifically, to a histogram-based corner screening method and device.

### BACKGROUND

Corner points play a critical role in machine vision applications, such as image matching, image stitching, object tracking, and target localization. When using corner points, extracted corners from an image are typically processed to select higher-scoring ones for subsequent algorithmic operations. For example, a 640×480 resolution image may yield hundreds or even thousands of corners in texture-rich scenarios. However, most algorithms require only a few dozen or fewer than 200 corners to achieve sufficient performance, necessitating the removal of approximately 50%-80% of detected corners.

Conventional approaches often employ sorting algorithms (e.g., selection sort, bubble sort, or insertion sort) to rank corners by their scores in descending order, followed by selecting a fixed number of high-scoring corners.

Nevertheless, these sorting algorithms suffer from high computational complexity, consume significant computational resources during the screening process, and result in low screening efficiency.

### SUMMARY

In various aspects, a histogram-based corner screening method, device, and a non-transitory computer-readable medium, are provided are disclosed in the present disclosure.

In one aspect, a method for histogram-based corner point screening includes, in response to a number of corner points in a current frame image exceeding a preset quantity threshold, determining histogram parameters of the current frame image. The determining histogram parameters of the current frame image is based on: (i) endpoints of groups in a histogram of a preceding frame image, where the groups are ranked in descending order of frequency up to a predefined rank, and (ii) histogram parameters of the preceding frame image. The method further includes, determining endpoints and frequencies of the groups in the histogram of the current frame image, determining a number of target corner points, determining a critical group where a critical corner point is located, predicting a score of the critical corner point based on endpoints of the critical group where the critical corner point is located. Where the target corner points are either corner points to be screened out or retained corner points, the critical corner point is either a highest-scoring corner point among those to be screened out or a lowest-scoring corner point among those retained, and the score of the critical corner point and the endpoints of the critical group define a first interval and a second interval. The method further includes, determining the target corner points based on: (i) the number of the target corner points, (ii) the number of corner points in the first interval, and (iii) the number of corner points in the second interval.

In some implementations, the histogram parameters of the preceding frame image includes a first endpoint, a second endpoint, and a group interval between endpoints within an interval defined by the first endpoint and the second endpoint. The group interval between the endpoints within the interval defined by the first endpoint and the second endpoint is smaller than the group interval between the endpoints outside the interval defined by the first endpoint and the second endpoint. And the interval defined by the first endpoint and the second endpoint overlaps with an interval defined by the groups ranked above the predefined rank.

In some implementations, determining the endpoints and the frequencies of the groups in the histogram of the current frame image is based on preset scores of corner points in the current frame image and the histogram parameters of the current frame image. Determining the number of the target corner points is based on the number of corner points in the current frame image and the preset quantity threshold. And determining the critical group where the critical corner point is located is based on the number of the target corner points and the frequencies of the groups.

In some implementations, determining the histogram parameters of the current frame image based on: (i) endpoints of groups in the histogram of the preceding frame image, where the groups are ranked in descending order of frequency up to the predefined rank, and (ii) the histogram parameters of the preceding frame image, further includes, in response to determining that a sum of a number of corner points in the first interval and the second interval of the preceding frame image does not exceed a preset sorting threshold, determining that the histogram parameters of the current frame image as identical to those of the preceding frame image.

In some implementations, determining the histogram parameters of the current frame image based on: (i) endpoints of groups in the histogram of the preceding frame image, where the groups are ranked in descending order of frequency up to the predefined rank, and (ii) the histogram parameters of the preceding frame image, further includes, in response to determining that: (i) a sum of corner points in the first interval and the second interval of the preceding frame image exceeds a preset sorting threshold, and (ii) a left endpoint of a highest-frequency group in the histogram of the preceding frame image is greater than its second endpoint, then: determining a first endpoint in the histogram of the current frame image based on: (i) the left endpoint of the highest-frequency group in the histogram of the preceding frame image; and (ii) the group interval between endpoints within the interval defined by the first endpoint and the second endpoint in the histogram of the preceding frame image. The method further includes, determining a second endpoint in the histogram of the current frame image based on: (i) the first endpoint in the histogram of the preceding frame image; and (ii) the group interval between endpoints within the interval defined by the first endpoint and the second endpoint in the histogram of the preceding frame image; and determining the group interval between endpoints within the interval defined by the first endpoint and the second endpoint in the histogram of the current frame image based on the first endpoint and the second endpoint in the histogram of the current frame image. The score of the corner point at the second endpoint is greater than the score of the corner point at the first endpoint.

In some implementations, determining the histogram parameters of the current frame image based on: (i) endpoints of groups in the histogram of the preceding frame image, where the groups are ranked in descending order of frequency up to the predefined rank, and (ii) the histogram parameters of the preceding frame image, further includes, in response to determining that: (i) a sum of corner points in the first interval and the second interval of the preceding frame image exceeds a preset sorting threshold, and (ii) a right endpoint of the highest-frequency group in the histogram of the preceding frame image does not exceed its first endpoint, then: determining the first endpoint in the histogram of the current frame image based on: the first endpoint in the histogram of the preceding frame image; and the group interval between the first endpoint and the second endpoint in the histogram of the preceding frame image. The method further includes, determining the group interval between the first endpoint and the second endpoint in the histogram of the current frame image based on the group interval between the first endpoint and the second endpoint in the histogram of the preceding frame image; and determining the second endpoint in the histogram of the current frame image based on: the first endpoint in the histogram of the current frame image and the group interval between the first endpoint and the second endpoint in the histogram of the current frame image. The score of the corner point at the second endpoint is greater than the score at the first endpoint.

In some implementations, determining the histogram parameters of the current frame image based on: (i) endpoints of groups in the histogram of the preceding frame image, where the groups are ranked in descending order of frequency up to the predefined rank, and (ii) the histogram parameters of the preceding frame image, further includes, in response to determining that: (i) a sum of corner points in the first interval and the second interval of the preceding frame image exceeds a preset sorting threshold, (ii) the left endpoint of the highest-frequency group in the histogram of the preceding frame image does not exceed its second endpoint, and (iii) the right endpoint of the highest-frequency group in the histogram of the preceding frame image exceeds its first endpoint, then: determining that the histogram parameters of the current frame image is identical to those of the preceding frame image. The score of the corner point at the second endpoint is greater than the score of the corner point at the first endpoint.

In some implementations, predicting the score of the critical corner point includes, predicting the score based on: (i) the endpoints of the critical group, (ii) the number of target corner points, (iii) a cumulative frequency of target groups, and (iv) a sum of the cumulative frequency of the critical group where the critical corner point is located and that of the target groups. The target groups are groups positioned to the left of the group containing the target corner point.

In some implementations, the target corner points are defined as corner points to be screened out, and determining the target corner points based on: (i) the number of the target corner points, (ii) the number of corner points in the first interval, and (iii) the number of corner points in the second interval, further includes, (a) in response to a sum of a cumulative frequency of target groups and a number of corner points in the first interval exceeds the number of corner points to be screened out, (i) sorting the corner points in the first interval in descending order of their scores, (ii) determining a first number of corner points sorted from the first interval, and (iii) determining all corner points in the target groups and the first number of corner points sorted from the first interval as corner points to be screened out. The first number is defined as a numerical difference between (i) the number of corner points to be screened out; and (ii) the cumulative frequency of the target groups. The determining the target corner points based on: (i) the number of the target corner points, (ii) the number of corner points in the first interval, and (iii) the number of corner points in the second interval, further includes, (b) in response to determining that the sum of: (i) the cumulative frequency of the target groups; and (ii) the number of corner points in the first interval, equals the number of corner points to be screened out, determining all corner points in the target groups and all corner points in the first interval as corner points to be screened out. And determining the target corner points based on: (i) the number of the target corner points, (ii) the number of corner points in the first interval, and (iii) the number of corner points in the second interval, further includes, (c) in response to determining that the sum of: (i) the cumulative frequency of the target groups; and (ii) the number of corner points in the first interval, exceeds the number of corner points to be screened out, sorting the corner points in the second interval in ascending order of their scores, determining a second number of corner points sorted from the second interval, and determining all corner points in the target groups, all the corner points in the first interval, and the second number of corner points sorted from the second interval as corner points to be screened out. The second number is defined as a numerical difference between: (i) the number of corner points to be screened out; and (ii) the sum of: the number of corner points in the first interval, and the cumulative frequency of the target groups. Groups positioned to the left of the target group where the target corner point is located are defined as the target groups.

In another aspect, an electronic device, includes a memory storing one or more programs; and a processor coupled to the memory and configured to execute the one or more programs, where when the one or more programs are executed by the processor, cause the processor to perform a histogram-based corner point screening method. The method includes, in response to a number of corner points in a current frame image exceeding a preset quantity threshold, determining histogram parameters of the current frame image. Where the determining histogram parameters of the current frame image is based on: (i) endpoints of groups in a histogram of a preceding frame image, where the groups are ranked in descending order of frequency up to a predefined rank, and (ii) histogram parameters of the preceding frame image. The method further includes, determining endpoints and frequencies of the groups in the histogram of the current frame image, determining a number of target corner points, determining a critical group where a critical corner point is located, predicting a score of the critical corner point based on endpoints of the critical group where the critical corner point is located. Where the target corner points are either corner points to be screened out or retained corner points, the critical corner point is either a highest-scoring corner point among those to be screened out or a lowest-scoring corner point among those retained, and the score of the critical corner point and the endpoints of the critical group define a first interval and a second interval. The method further includes, determining the target corner points based on: (i) the number of the target corner points, (ii) the number of corner points in the first interval, and (iii) the number of corner points in the second interval.

In some implementations, the histogram parameters of the preceding frame image includes a first endpoint, a second endpoint, and a group interval between endpoints within an interval defined by the first endpoint and the second endpoint. The group interval between the endpoints within the interval defined by the first endpoint and the second endpoint is smaller than the group interval between the endpoints outside the interval defined by the first endpoint and the second endpoint. And the interval defined by the first endpoint and the second endpoint overlaps with an interval defined by the groups ranked above the predefined rank.

In some implementations, determining the endpoints and the frequencies of the groups in the histogram of the current frame image is based on preset scores of corner points in the current frame image and the histogram parameters of the current frame image. Determining the number of the target corner points is based on the number of corner points in the current frame image and the preset quantity threshold. And determining the critical group where the critical corner point is located is based on the number of the target corner points and the frequencies of the groups.

In some implementations, determining the histogram parameters of the current frame image based on: (i) endpoints of groups in the histogram of the preceding frame image, where the groups are ranked in descending order of frequency up to the predefined rank, and (ii) the histogram parameters of the preceding frame image, further includes, in response to determining that a sum of a number of corner points in the first interval and the second interval of the preceding frame image does not exceed a preset sorting threshold, determining that the histogram parameters of the current frame image as identical to those of the preceding frame image.

In some implementations, determining the histogram parameters of the current frame image based on: (i) endpoints of groups in the histogram of the preceding frame image, where the groups are ranked in descending order of frequency up to the predefined rank, and (ii) the histogram parameters of the preceding frame image, further includes, in response to determining that: (i) a sum of corner points in the first interval and the second interval of the preceding frame image exceeds a preset sorting threshold, and (ii) a left endpoint of a highest-frequency group in the histogram of the preceding frame image is greater than its second endpoint, then: determining a first endpoint in the histogram of the current frame image based on: (i) the left endpoint of the highest-frequency group in the histogram of the preceding frame image; and (ii) the group interval between endpoints within the interval defined by the first endpoint and the second endpoint in the histogram of the preceding frame image. The method further includes, determining a second endpoint in the histogram of the current frame image based on: (i) the first endpoint in the histogram of the preceding frame image; and (ii) the group interval between endpoints within the interval defined by the first endpoint and the second endpoint in the histogram of the preceding frame image; and determining the group interval between endpoints within the interval defined by the first endpoint and the second endpoint in the histogram of the current frame image based on the first endpoint and the second endpoint in the histogram of the current frame image. The score of the corner point at the second endpoint is greater than the score of the corner point at the first endpoint.

In some implementations, determining the histogram parameters of the current frame image based on: (i) endpoints of groups in the histogram of the preceding frame image, where the groups are ranked in descending order of frequency up to the predefined rank, and (ii) the histogram parameters of the preceding frame image, further includes, in response to determining that: (i) a sum of corner points in the first interval and the second interval of the preceding frame image exceeds a preset sorting threshold, and (ii) a right endpoint of the highest-frequency group in the histogram of the preceding frame image does not exceed its first endpoint, then: determining the first endpoint in the histogram of the current frame image based on: the first endpoint in the histogram of the preceding frame image; and the group interval between the first endpoint and the second endpoint in the histogram of the preceding frame image. The method further includes, determining the group interval between the first endpoint and the second endpoint in the histogram of the current frame image based on the group interval between the first endpoint and the second endpoint in the histogram of the preceding frame image; and determining the second endpoint in the histogram of the current frame image based on: the first endpoint in the histogram of the current frame image and the group interval between the first endpoint and the second endpoint in the histogram of the current frame image. The score of the corner point at the second endpoint is greater than the score at the first endpoint.

In some implementations, determining the histogram parameters of the current frame image based on: (i) endpoints of groups in the histogram of the preceding frame image, where the groups are ranked in descending order of frequency up to the predefined rank, and (ii) the histogram parameters of the preceding frame image, further includes, in response to determining that: (i) a sum of corner points in the first interval and the second interval of the preceding frame image exceeds a preset sorting threshold, (ii) the left endpoint of the highest-frequency group in the histogram of the preceding frame image does not exceed its second endpoint, and (iii) the right endpoint of the highest-frequency group in the histogram of the preceding frame image exceeds its first endpoint, then: determining that the histogram parameters of the current frame image is identical to those of the preceding frame image. The score of the corner point at the second endpoint is greater than the score of the corner point at the first endpoint.

In some implementations, predicting the score of the critical corner point includes, predicting the score based on: (i) the endpoints of the critical group, (ii) the number of target corner points, (iii) a cumulative frequency of target groups, and (iv) a sum of the cumulative frequency of the critical group where the critical corner point is located and that of the target groups. The target groups are groups positioned to the left of the group containing the target corner point.

In some implementations, the target corner points are defined as corner points to be screened out, and determining the target corner points based on: (i) the number of the target corner points, (ii) the number of corner points in the first interval, and (iii) the number of corner points in the second interval, further includes, (a) in response to a sum of a cumulative frequency of target groups and a number of corner points in the first interval exceeds the number of corner points to be screened out, (i) sorting the corner points in the first interval in descending order of their scores, (ii) determining a first number of corner points sorted from the first interval, and (iii) determining all corner points in the target groups and the first number of corner points sorted from the first interval as corner points to be screened out. The first number is defined as a numerical difference between (i) the number of corner points to be screened out; and (ii) the cumulative frequency of the target groups. The determining the target corner points based on: (i) the number of the target corner points, (ii) the number of corner points in the first interval, and (iii) the number of corner points in the second interval, further includes, (b) in response to determining that the sum of: (i) the cumulative frequency of the target groups; and (ii) the number of corner points in the first interval, equals the number of corner points to be screened out, determining all corner points in the target groups and all corner points in the first interval as corner points to be screened out. And determining the target corner points based on: (i) the number of the target corner points, (ii) the number of corner points in the first interval, and (iii) the number of corner points in the second interval, further includes, (c) in response to determining that the sum of: (i) the cumulative frequency of the target groups; and (ii) the number of corner points in the first interval, exceeds the number of corner points to be screened out, sorting the corner points in the second interval in ascending order of their scores, determining a second number of corner points sorted from the second interval, and determining all corner points in the target groups, all the corner points in the first interval, and the second number of corner points sorted from the second interval as corner points to be screened out. The second number is defined as a numerical difference between: (i) the number of corner points to be screened out; and (ii) the sum of: the number of corner points in the first interval, and the cumulative frequency of the target groups. Groups positioned to the left of the target group where the target corner point is located are defined as the target groups.

In still another aspect, a non-transitory computer-readable medium storing instructions that, when executed by a processor, cause the processor to perform a histogram-based corner point screening method. The method includes, in response to a number of corner points in a current frame image exceeding a preset quantity threshold, determining histogram parameters of the current frame image. Where the determining histogram parameters of the current frame image is based on: (i) endpoints of groups in a histogram of a preceding frame image, where the groups are ranked in descending order of frequency up to a predefined rank, and (ii) histogram parameters of the preceding frame image. The method further includes, determining endpoints and frequencies of the groups in the histogram of the current frame image, determining a number of target corner points, determining a critical group where a critical corner point is located, predicting a score of the critical corner point based on endpoints of the critical group where the critical corner point is located. Where the target corner points are either corner points to be screened out or retained corner points, the critical corner point is either a highest-scoring corner point among those to be screened out or a lowest-scoring corner point among those retained, and the score of the critical corner point and the endpoints of the critical group define a first interval and a second interval. The method further includes, determining the target corner points based on: (i) the number of the target corner points, (ii) the number of corner points in the first interval, and (iii) the number of corner points in the second interval.

In some implementations, the histogram parameters of the preceding frame image includes a first endpoint, a second endpoint, and a group interval between endpoints within an interval defined by the first endpoint and the second endpoint. The group interval between the endpoints within the interval defined by the first endpoint and the second endpoint is smaller than the group interval between the endpoints outside the interval defined by the first endpoint and the second endpoint. And the interval defined by the first endpoint and the second endpoint overlaps with an interval defined by the groups ranked above the predefined rank.

In some implementations, determining the endpoints and the frequencies of the groups in the histogram of the current frame image is based on preset scores of corner points in the current frame image and the histogram parameters of the current frame image. Determining the number of the target corner points is based on the number of corner points in the current frame image and the preset quantity threshold. And determining the critical group where the critical corner point is located is based on the number of the target corner points and the frequencies of the groups.

In some implementations, determining the histogram parameters of the current frame image based on: (i) endpoints of groups in the histogram of the preceding frame image, where the groups are ranked in descending order of frequency up to the predefined rank, and (ii) the histogram parameters of the preceding frame image, further includes, in response to determining that a sum of a number of corner points in the first interval and the second interval of the preceding frame image does not exceed a preset sorting threshold, determining that the histogram parameters of the current frame image as identical to those of the preceding frame image.

In some implementations, determining the histogram parameters of the current frame image based on: (i) endpoints of groups in the histogram of the preceding frame image, where the groups are ranked in descending order of frequency up to the predefined rank, and (ii) the histogram parameters of the preceding frame image, further includes, in response to determining that: (i) a sum of corner points in the first interval and the second interval of the preceding frame image exceeds a preset sorting threshold, and (ii) a left endpoint of a highest-frequency group in the histogram of the preceding frame image is greater than its second endpoint, then: determining a first endpoint in the histogram of the current frame image based on: (i) the left endpoint of the highest-frequency group in the histogram of the preceding frame image; and (ii) the group interval between endpoints within the interval defined by the first endpoint and the second endpoint in the histogram of the preceding frame image. The method further includes, determining a second endpoint in the histogram of the current frame image based on: (i) the first endpoint in the histogram of the preceding frame image; and (ii) the group interval between endpoints within the interval defined by the first endpoint and the second endpoint in the histogram of the preceding frame image; and determining the group interval between endpoints within the interval defined by the first endpoint and the second endpoint in the histogram of the current frame image based on the first endpoint and the second endpoint in the histogram of the current frame image. The score of the corner point at the second endpoint is greater than the score of the corner point at the first endpoint.

In some implementations, determining the histogram parameters of the current frame image based on: (i) endpoints of groups in the histogram of the preceding frame image, where the groups are ranked in descending order of frequency up to the predefined rank, and (ii) the histogram parameters of the preceding frame image, further includes, in response to determining that: (i) a sum of corner points in the first interval and the second interval of the preceding frame image exceeds a preset sorting threshold, and (ii) a right endpoint of the highest-frequency group in the histogram of the preceding frame image does not exceed its first endpoint, then: determining the first endpoint in the histogram of the current frame image based on: the first endpoint in the histogram of the preceding frame image; and the group interval between the first endpoint and the second endpoint in the histogram of the preceding frame image. The method further includes, determining the group interval between the first endpoint and the second endpoint in the histogram of the current frame image based on the group interval between the first endpoint and the second endpoint in the histogram of the preceding frame image; and determining the second endpoint in the histogram of the current frame image based on: the first endpoint in the histogram of the current frame image and the group interval between the first endpoint and the second endpoint in the histogram of the current frame image. The score of the corner point at the second endpoint is greater than the score at the first endpoint.

In some implementations, determining the histogram parameters of the current frame image based on: (i) endpoints of groups in the histogram of the preceding frame image, where the groups are ranked in descending order of frequency up to the predefined rank, and (ii) the histogram parameters of the preceding frame image, further includes, in response to determining that: (i) a sum of corner points in the first interval and the second interval of the preceding frame image exceeds a preset sorting threshold, (ii) the left endpoint of the highest-frequency group in the histogram of the preceding frame image does not exceed its second endpoint, and (iii) the right endpoint of the highest-frequency group in the histogram of the preceding frame image exceeds its first endpoint, then: determining that the histogram parameters of the current frame image is identical to those of the preceding frame image. The score of the corner point at the second endpoint is greater than the score of the corner point at the first endpoint.

In some implementations, predicting the score of the critical corner point includes, predicting the score based on: (i) the endpoints of the critical group, (ii) the number of target corner points, (iii) a cumulative frequency of target groups, and (iv) a sum of the cumulative frequency of the critical group where the critical corner point is located and that of the target groups. The target groups are groups positioned to the left of the group containing the target corner point.

In some implementations, the target corner points are defined as corner points to be screened out, and determining the target corner points based on: (i) the number of the target corner points, (ii) the number of corner points in the first interval, and (iii) the number of corner points in the second interval, further includes, (a) in response to a sum of a cumulative frequency of target groups and a number of corner points in the first interval exceeds the number of corner points to be screened out, (i) sorting the corner points in the first interval in descending order of their scores, (ii) determining a first number of corner points sorted from the first interval, and (iii) determining all corner points in the target groups and the first number of corner points sorted from the first interval as corner points to be screened out. The first number is defined as a numerical difference between (i) the number of corner points to be screened out; and (ii) the cumulative frequency of the target groups. The determining the target corner points based on: (i) the number of the target corner points, (ii) the number of corner points in the first interval, and (iii) the number of corner points in the second interval, further includes, (b) in response to determining that the sum of: (i) the cumulative frequency of the target groups; and (ii) the number of corner points in the first interval, equals the number of corner points to be screened out, determining all corner points in the target groups and all corner points in the first interval as corner points to be screened out. And determining the target corner points based on: (i) the number of the target corner points, (ii) the number of corner points in the first interval, and (iii) the number of corner points in the second interval, further includes, (c) in response to determining that the sum of: (i) the cumulative frequency of the target groups; and (ii) the number of corner points in the first interval, exceeds the number of corner points to be screened out, sorting the corner points in the second interval in ascending order of their scores, determining a second number of corner points sorted from the second interval, and determining all corner points in the target groups, all the corner points in the first interval, and the second number of corner points sorted from the second interval as corner points to be screened out. The second number is defined as a numerical difference between: (i) the number of corner points to be screened out; and (ii) the sum of: the number of corner points in the first interval, and the cumulative frequency of the target groups. Groups positioned to the left of the target group where the target corner point is located are defined as the target groups.

Other aspects of the present disclosure can be understood by those skilled in the art in light of the description, the claims, and the drawings of the present disclosure.

### BRIEF DESCRIPTION OF THE DRAWINGS

The accompanying drawings, which are incorporated herein and form a part of the specification, illustrate aspects of the present disclosure and, together with the description, further serve to explain the principles of the present disclosure and to enable a person skilled in the pertinent art to make and use the present disclosure.

It is noted that the drawings in the present application are not necessarily drawn to scale, the same reference numerals may be used in different views to describe similar components. Identical reference numerals with letter suffixes or differing suffixes may denote different instances of similar components. The same reference numerals used across all figures may refer to the same or similar parts. However, these embodiments are illustrative and are not intended to be exhaustive or exclusive representations of the apparatus or method.

FIG. 1 is a flowchart of a histogram-based corner screening method according to some implementations of the present application;

FIG. 2A is a schematic diagram of a histogram according to some implementations of the present application;

FIG. 2B is a schematic diagram of a histogram according to some implementations of the present application;

FIG. 3 is a schematic diagram of a histogram-based corner screening device according to some implementations of the present application; and

FIG. 4 is a structural schematic diagram of a histogram-based corner screening device in accordance with some implementations of the present disclosure.

The present disclosure will be described with reference to the accompanying drawings.

### DETAILED DESCRIPTION

Although specific configurations and arrangements are discussed, it should be understood that this is done for illustrative purposes only. As such, other configurations and arrangements can be used without departing from the scope of the present disclosure. Also, the present disclosure can also be employed in a variety of other applications. Functional and structural features as described in the present disclosures can be combined, adjusted, and modified with one another and in ways not specifically depicted in the drawings, such that these combinations, adjustments, and modifications are within the scope of the present disclosure.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

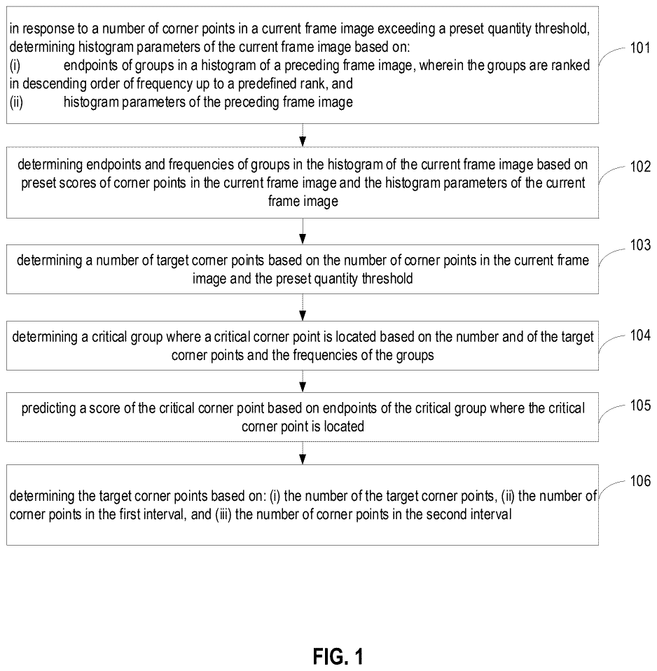

FIG. 1 is a flowchart of a histogram-based corner screening method according to some implementations of the present application. As shown in FIG. 1, a histogram-based corner screening method includes:

Step 101: In response to the number of corners in the current frame image exceeding a preset quantity threshold, determine the histogram parameters of the current frame image based on: (1) the endpoints of groups ranked before a specified rank (sorted by frequency in descending order) in the histogram of the preceding frame image; and (2) the histogram parameters of the preceding frame image.

If the detected number of corners in the current frame image exceeds the quantity threshold, corner screening is required; otherwise, all detected corners are retained without screening. In practical scenarios, the groups ranked before the specified rank may be one or multiple. For example, the histogram parameters of the current frame image may be determined by using the endpoints of the highest-frequency group and the histogram parameters of the preceding frame image, or by combining the endpoints of the two highest-frequency groups with the histogram parameters of the preceding frame image. The specified rank may be adjusted or pre-determined according to actual application requirements. Based on the endpoints of the groups ranked before the specified rank and the histogram parameters of the preceding frame image, it can be determined whether adjustments to the histogram parameters of the current frame image are necessary relative to the preceding frame image.

The histogram parameters of the preceding frame image include: a first endpoint; a second endpoint; and a group interval between endpoints within the interval defined by the first and second endpoints.

In some implementations, the group interval between the endpoints within the interval defined by the first and second endpoints is smaller than the group interval between the endpoints outside this interval. Additionally, the interval defined by the first and second endpoints overlaps with the interval defined by the groups ranked before the specified rank.

Step 102: Determining endpoints and frequencies of groups in the histogram of the current frame image based on pre-determined scores of each corner points in the current frame image and histogram parameters of the current frame image.

In some implementations, it includes determining a starting endpoint and a terminating endpoint in the histogram based on the scores of each corner points in the current frame image, and determining endpoints of groups in the histogram based on the starting endpoint, terminating endpoint, and histogram parameters.

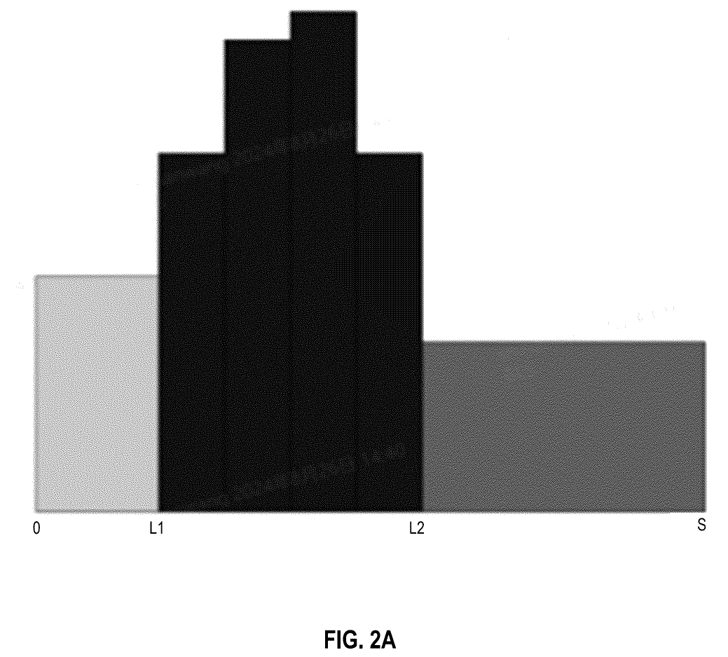

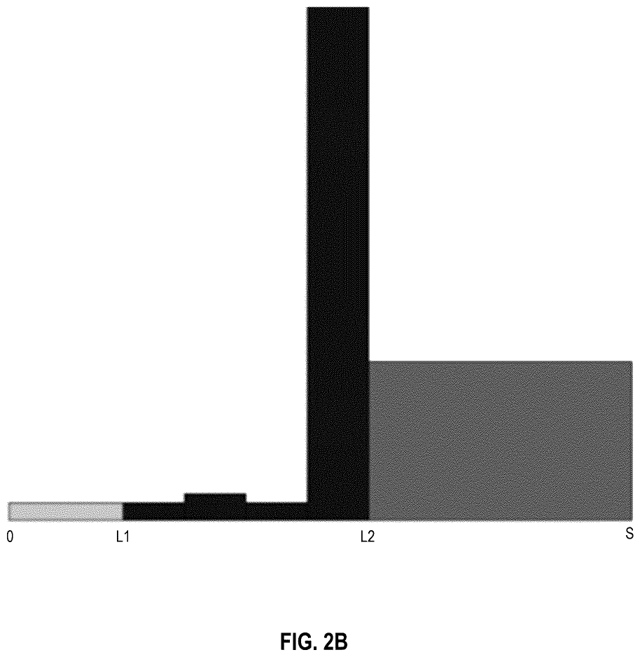

For example, as shown in FIG. 2A, if the score range of the corner points is [0, S], the starting endpoint is 0, the terminating endpoint is S, a first endpoint is L1, a second endpoint is L2 (where the score at L2 is greater than that at L1), and L1 and L2 lie between the starting endpoint 0 and terminating endpoint S. Within the interval defined by the first endpoint L1 and the second endpoint L2, each group interval is uniformly set to len. The histogram groups are divided as: [0, L1), [L1, L1+len), . . . , [L1+m×len, L2), [L2, S]. The frequencies of each groups are determined based on the scores of the corner points and the group endpoints. For instance, if a corner point's score falls within [L1, L1+len), the frequency of [L1, L1+len) is incremented by 1. In some implementations, m may be adjusted according to L1 and L2. For example, m may represent the number of groups between L1 and L2, e.g., m=(L2−L1)/len.

Step 103: Determining a number of target corner points based on the number of corner points in the current frame image and the preset quantity threshold.

The target corner points are either to be screened out or retained (retained corner points refer to those required to be kept, with their number equal to the preset quantity threshold). If the number of corner points in the current frame image is M and the preset quantity threshold is N, the number of corner points to be screened out, K, is calculated as K=M−N.

Step 104: Determining a critical group including a critical corner point based on the number of the target corner points and the frequencies of each groups.

The critical corner point is either (i) the highest-scoring corner point among those to be screened out or (ii) the lowest-scoring corner point among the retained corner points. The frequencies of each groups are cumulatively summed as follows: P1=I1, P2=P1+I2, . . . , Pn=Pn−1+In, where In denotes the frequency of the n-th group, and Pn represents the cumulative sum of frequencies up to the n-th group. Taking the screening-out corner points as an example, based on the frequencies and endpoints of each groups, along with the number of corner points to be screened out K, the group including the K-th corner point to be screened out can be identified. The K-th corner point to be screened out corresponds to the corner point ranked at the K-th position when all corner points are ordered in ascending sequence of their scores.

Step 105: Predicting a score of the critical corner point based on the endpoints of the critical group including the critical corner point.

The predicted score of the critical corner point and the two endpoints of the critical group define a first interval and a second interval, respectively. The score of the critical corner point is predicted based on (i) the endpoints and frequency of the critical group, and (ii) the frequencies of groups preceding the critical group in the histogram.

Step 106: Determining the target corner points based on (i) the number of target corner points, (ii) the number of corner points in the first interval, and (iii) the number of corner points in the second interval.

Based on the predicted score of the critical corner point, the critical group is partitioned into a first interval and a second interval, e.g., [Lᵢ, V) and [V, Lᵢ₊₁), where Lᵢ and Lᵢ₊₁ are the endpoints of the critical group. The numbers of corner points in the first and second intervals are then counted.

To account for temporal continuity between sequential frames, where image features typically exhibit gradual changes rather than abrupt variations, embodiments of the present application utilize the histogram parameters of the preceding frame as a reference to determine the histogram parameters of the current frame. This approach ensures that the derived histogram parameters for the current frame align more closely with real-world conditions, thereby enhancing the accuracy and efficiency of corner point screening. The histogram parameters are adaptively adjusted based on group frequencies, such that groups with higher frequencies are concentrated between the first endpoint (L1) and the second endpoint (L2). Since the group interval between L1 and L2 is smaller than intervals outside this range, the reduced group interval within L1−L2 results in fewer corner points per group. This significantly decreases the number of corner points involved in subsequent screening processes.

For example, if the critical corner point resides in Group A, a larger group interval would necessitate processing a larger number of corner points in subsequent sorting or screening steps, adversely affecting screening efficiency. Conversely, a smaller group interval allows for preemptive exclusion of non-critical corner points by identifying the critical group where the critical corner points located, thereby reducing the number of corner points requiring further sorting or screening and improving overall efficiency.

In some implementations, determining the histogram parameters of the current frame image based on (i) endpoints of groups in the histogram of the preceding frame image, where the groups are ranked in descending order of frequency up to a predefined rank, and (ii) histogram parameters of the preceding frame image, further includes: in response to a determination that a sum of corner points in the first interval and the second interval of the preceding frame image does not exceed a preset sorting threshold, determining that the histogram parameters of the current frame image is identical to those of the preceding frame image.

To regulate computational complexity and resource consumption, the present application determines whether to adjust histogram parameters based on the preset sorting threshold. For example, a larger sorting threshold allows more corner points to be sorted but may demand greater computational resources. The sorting threshold may be adjusted according to practical application requirements. For example, in one scenario, the sorting threshold is set to 50, while in another scenario, it is set to 100. If the number of corner points does not exceed the sorting threshold, the computational resources consumed during sorting are deemed acceptable, and the histogram parameters of the current frame image are retained as identical to those of the preceding frame image. This avoids unnecessary adjustments to the histogram parameters of the preceding frame image to derive the histogram parameters of the current frame image, thereby conserving computational resources.

In some implementations, determining the histogram parameters of the current frame image based on (i) endpoints of groups in the histogram of the preceding frame image, where the groups are ranked in descending order of frequency up to a predefined rank, and (ii) histogram parameters of the preceding frame image, further includes: in response to determining that: (i) a sum of corner points in the first interval and the second interval of the preceding frame image exceeds a preset sorting threshold, and (ii) a left endpoint of a highest-frequency group in the histogram of the preceding frame image is greater than its second endpoint, then: (a) determining a first endpoint in the histogram of the current frame image based on (i) the left endpoint of the highest-frequency group in the histogram of the preceding frame image; and (ii) the group interval between endpoints within the first and second endpoints of the histogram of the preceding frame image; (b) determining a second endpoint in the histogram of the current frame image based on (i) the first endpoint in the histogram of the preceding frame image; and (ii) the group interval between endpoints within the first and second endpoints of the histogram of the preceding frame image; and (c) determining the group interval between endpoints within the first and second endpoints in the histogram of the current frame image based on the first and second endpoints in the histogram of the current frame image. The score of the corner point at the second endpoint is greater than the score of the corner point at the first endpoint.

In some implementations, if the left endpoint of the highest-frequency group in the histogram of the preceding frame image is larger than its second endpoint, this indicates that the histogram's peak is skewed toward higher-score regions (e.g., right regions), which also indicates that the first and second endpoints (L1 and L2) are initially positioned at lower values than required. Consequently, both the first and second endpoints are dynamically adjusted to higher values (e.g., adjust toward higher-score regions along the score axis) to better encompass the concentrated peak distribution.

In some implementations, adjustment strategies may include: adjusting the first and second endpoints based on the endpoints of the highest-frequency group; adjusting the endpoints by applying a fixed numerical increment; adjusting the first endpoint in the histogram of the current frame image based on the first endpoint in the histogram of the preceding frame image, and similarly adjusting the second endpoint in the histogram of the current frame image based on the second endpoint in the histogram of the preceding frame image.

For instance, the second endpoint in the histogram of the current frame image may be determined based on: (i) the right endpoint of the highest-frequency group in the histogram of the preceding frame image; and (ii) the group interval between endpoints within the first and second endpoints in the histogram of the preceding frame image.

In some implementations, the first endpoint in the histogram of the current frame image is determined as the left endpoint of the highest-frequency group in the histogram of the preceding frame image minus twice of the group interval, and the second endpoint in the histogram of the current frame image is determined as the second endpoint in the histogram of the preceding frame image plus twice of the group interval. Where “twice of the group interval” refers to twice the group interval between the first and second endpoints in the histogram of the preceding frame image.

The group interval between the first and second endpoints in the histogram of the current frame image is calculated by dividing the difference between the endpoints in the histogram of the current frame image by the number of groups between the first and second endpoints in the histogram of the preceding frame image. Where the difference between the endpoints is defined as the numerical difference between the second endpoint and the first endpoint in the histogram of the current frame image.

In practical application scenarios, the relationship between the number of corner points and the sorting threshold need not be evaluated; instead, only the relationship between the left endpoint of the highest-frequency group in the histogram of the preceding frame image and its second endpoint is analyzed.

In some implementations, determining the histogram parameters of the current frame image based on (i) endpoints of groups in the histogram of the preceding frame image, where the groups are ranked in descending order of frequency up to a predefined rank, and (ii) histogram parameters of the preceding frame image, further includes: in response to determining that: (i) a sum of corner points in the first interval and the second interval of the preceding frame image exceeds a preset sorting threshold, and (ii) a right endpoint of the highest-frequency group in the histogram of the preceding frame image does not exceed its first endpoint, then: (a) determining the first endpoint in the histogram of the current frame image as the first endpoint in the histogram of the preceding frame image plus the group interval between the first and second endpoints in the histogram of the preceding frame image; (b) determining the group interval between the first and second endpoints in the histogram of the current frame image as equal to the group interval between the first and second endpoints in the histogram of the preceding frame image; and (c) determining the second endpoint in the histogram of the current frame image based on the first endpoint in the histogram of the current frame image and the group interval determined in (b). The score of the corner point at the second endpoint is greater than the score of the corner point at the first endpoint.

In some implementations analogous to the previous application scenario, if the right endpoint of the highest-frequency group in the histogram of the preceding frame image does not exceed its first endpoint (L1), this indicates that the histogram's peak is skewed toward lower-score regions (e.g., left regions), which also indicates that the first and second endpoints (L1 and L2) are initially positioned at higher values than required. Consequently, both L1 and L2 are dynamically adjusted to lower values (e.g., adjust toward lower-score regions along the score axis) to better align with the concentrated peak distribution.

In some implementations, adjustment strategies may include: adjusting the first and second endpoints based on the endpoints of the highest-frequency group; adjusting the endpoints by applying a fixed numerical decrement; adjusting the first endpoint in the histogram of the current frame image based on the first endpoint in the histogram of the preceding frame image, and similarly adjusting the second endpoint in the histogram of the current frame image based on the second endpoint in the histogram of the preceding frame image.

For instance, the first endpoint (L1) in the histogram of the current frame image may be determined based on (i) the left endpoint of the highest-frequency group in the histogram of the preceding frame image; and (ii) the group interval between the first and second endpoints (L1 and L2) in the histogram of the preceding frame image.

In some implementations, the first endpoint in the histogram of the current frame image is determined as the first endpoint in the histogram of the preceding frame image minus the group interval between the first and second endpoints in the histogram of the preceding frame image. The group interval between the first and second endpoints in the histogram of the current frame image is twice the group interval between the first and second endpoints in the histogram of the preceding frame image.

The second endpoint in the histogram of the current frame image is calculated as the first endpoint in the histogram of the current frame image plus a multiple of the group interval, where the multiple corresponds to or is equal to the product of: (i) the group interval between the first and second endpoints in the histogram of the current frame image; and (ii) the number of groups within the interval defined by the first and second endpoints in the histogram of the current frame image.

In practical application scenarios, the relationship between the number of corner points and the sorting threshold need not be evaluated; instead, only the relationship between the left endpoint of the highest-frequency group in the histogram of the preceding frame image and its second endpoint is analyzed.

In some implementations, determining the histogram parameters of the current frame image based on (i) endpoints of groups in the histogram of the preceding frame image, where the groups are ranked in descending order of frequency up to a predefined rank, and (ii) histogram parameters of the preceding frame image, further includes: in response to determining that: (i) a sum of corner points in the first interval and the second interval of the preceding frame image exceeds a preset sorting threshold, (ii) the left endpoint of the highest-frequency group in the histogram of the preceding frame image does not exceed its second endpoint, and (iii) the right endpoint of the highest-frequency group in the histogram of the preceding frame image exceeds its first endpoint, determining that the histogram parameters of the current frame image is identical to those of the preceding frame image. The score of the corner point at the second endpoint is greater than the score of the corner point at the first endpoint.

If the left endpoint of the highest-frequency group in the histogram of the preceding frame image does not exceed its second endpoint, and the right endpoint of the highest-frequency group exceeds its first endpoint, this indicates that the highest-frequency group overlaps with the interval defined by the first and second endpoints (L1 and L2), and the highest-frequency group has not deviated significantly from the interval defined by the first and second endpoints. Consequently, the histogram parameters of the preceding frame may be retained for the current frame image. As shown in FIG. 2B, when the highest-frequency group is positioned between L1 and L2, the histogram parameters of the preceding frame image are adopted as the histogram parameters of the current frame image.

The aforementioned three implementations adjust histogram parameters based on the relationship between the highest-frequency group and the first and second endpoints (L1 and L2), thereby inducing an overlap between the highest-frequency group and the interval defined by L1 and L2. This enables adaptive refinement of the group interval within the L1-L2 interval to achieve finer granularity for groups with higher frequencies. As a result, the method significantly reduces the number of corner points requiring in subsequent sorting or screening processes, thereby enhancing the efficiency of corner point screening.

In some implementations, predicting the score of the critical corner point based on the endpoints of the critical group where the critical corner point located, includes, predicting the score of the critical corner point based on (i) the endpoints of the critical group where the critical corner point located; (ii) the number of target corner points; (iii) the cumulative frequency of the target groups; and (iv) the cumulative frequency of the critical group where the critical corner point located combined with that of the target groups. The target groups are defined as groups positioned to the left of the critical group where the critical corner point located.

In some implementations, the score of the critical corner point may be predicted using Equation (1):

$$V = L\_i + ( P\_ ( i + 1 ) - K ) / ( P\_ ( i + 1 ) - P\_i ) \times ( {L}_{i + 1} ) - L\_i ) \qquad ( 1 )$$

where:
V represents the score of the critical corner point;
the critical group where the critical corner point located is defined by the interval [Lᵢ, Lᵢ₊₁);
Pᵢ₊₁ denotes the cumulative frequency of the first i+1 groups;
Pᵢ denotes the cumulative frequency of the first i groups;
the critical corner point is located in the (i+1)-th group.

This implementation enables estimation of the critical corner point's score, thereby allowing further subdivision of the group and reducing the number of corner points requiring in subsequent sorting or screening, which enhances computational efficiency.

In some implementations, the target corner points are defined as corner points to be screened out; and determining the target corner points based on (i) the number of target corner points, (ii) the number of corner points in the first interval, and (iii) the number of corner points in the second interval, includes: (a) in response to the sum of the cumulative frequency of the target groups and the number of corner points in the first interval exceeds the number of corner points to be screened out, (i) sorting the corner points in the first interval [Lᵢ, V) in descending order of their scores, (ii) determining a first number of corner points sorted from the first interval, and (iii) determining all corner points in the target groups and the first number of corner points sorted from the first interval as corner points to be screened out, where the first number is defined as the numerical difference between (i) the number of corner points to be screened out; and (ii) the cumulative frequency of the target groups; (b) in response to determining that the sum of: (i) the cumulative frequency of the target groups; and (ii) the number of corner points in the first interval, equals the number of corner points to be screened out, determining all corner points in the target groups and all corner points in the first interval as corner points to be screened out; and (c) in response to determining that the sum of: (i) the cumulative frequency of the target groups; and (ii) the number of corner points in the first interval, exceeds the number of corner points to be screened out, sorting the corner points in the second interval in ascending order of their scores, determining a second number of corner points sorted from the second interval, and determining all corner points in the target groups, all the corner points in the first interval, and the second number of corner points sorted from the second interval as corner points to be screened out.

The second number is defined as the numerical difference between: (i) the number of corner points to be screened out; and (ii) the sum of: the number of corner points in the first interval, and the cumulative frequency of the target groups. And groups positioned to the left of the target group where the target corner point is located are defined as the target groups.

For instance,
Pᵢ: Cumulative frequency of the target groups.
Q₁: Number of corner points within the interval [Lᵢ, V).
Q₂: Number of corner points within the interval [V, Lᵢ₊₁).

$$If {P}_{i} + {Q}_{1} > K ,$$

then all corner points in the interval [V, Lᵢ₊₁) are determined as retained corner points; and sorting the corner points in interval [Lᵢ, V) in descending order of their scores, and then the first (K−Pᵢ−Q₁) corner points from the sorted interval [Lᵢ, V) as retained corner points.

$$If {P}_{i} + {Q}_{1} = K ,$$

then all corner points in interval [V, Lᵢ₊₁) are determined as retained corner points, and all corner points in interval [Lᵢ, V) are determined as corner points to be screened out.

$$If Pi + Q 1 < K ,$$

then all corner points in interval [Li, V) are determined as corner points to be screened out; and sorting the corner points in interval [V, Li+1) in descending order of their scores, and then the first (Pᵢ₊₁−K) corner points from the sorted interval [V, Lᵢ₊₁) are determined as retained corner points.

It should be noted that, in the three aforementioned scenarios, if a corner point's score is lower than that of any corner point to be screened out, said corner point is determined as a corner point to be screened out. The embodiments of the present application are described using the example where the target corner points are those to be screened out. For retained corner points, the steps in the aforementioned implementations require adaptive adjustments, which are not detailed herein.

The implementations of the present application eliminate the need to sort all corner points within the interval [Lᵢ, Lᵢ₊₁), thereby significantly reducing computational load and improving screening efficiency.

Through dataset testing, it revealed that, for 90% of the images, the number of corner points requiring sorting does not exceed 26, demonstrating minimal computational overhead.

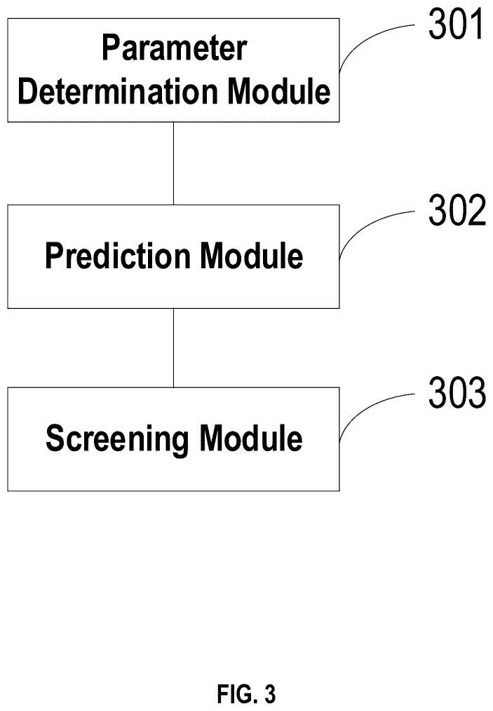

As shown in FIG. 3, in some implementations of the present application, a histogram-based corner point screening apparatus is provided. The histogram-based corner point screening apparatus includes: a Parameter Determination Module 301, a Prediction Module 302, and a Screening Module 303.

Parameter Determination Module 301, is configured to: in response to the number of corner points in the current frame image exceeding a preset quantity threshold, determine the histogram parameters of the current frame image based on: (i) endpoints of groups in the histogram of the preceding frame image, where the groups are ranked in descending order of frequency up to a predefined rank, and (ii) histogram parameters of the preceding frame image.

The histogram parameters of the preceding frame image include: a first endpoint (L1), a second endpoint (L2), and a group interval between endpoints within L1 and L2. The group interval between L1 and L2 is smaller than group intervals outside L1 and L2. The interval defined by L1 and L2 overlaps with the interval defined by groups ranked above the predefined rank.

Prediction Module 302, is configured to: determine endpoints and frequencies of each groups in the histogram of the current frame image based on preset scores of corner points in the current frame image and the histogram parameters of the current frame image; determine a number of target corner points based on the number of corner points in the current frame image and the preset quantity threshold; determine the critical group where the critical corner point is located based on: (i) the number of target corner points; and (ii) the frequencies of each groups; and predict the score of the critical corner point based on the endpoints of the critical group where the critical corner point is located. The target corner points are either corner points to be screened out or retained corner points; the critical corner point is either the highest-scoring corner point among those to be screened out or the lowest-scoring corner point among those retained; and the predicted score of the critical corner point and the two endpoints of the critical group where the critical corner point is located define a first interval and a second interval.

Screening Module 303, is configured to: determine the target corner points based on: (i) the number of target corner points, (ii) the number of corner points in the first interval, and (iii) the number of corner points in the second interval.

In some implementations, Parameter Determination Module 301 is configured to: in response to determining that the sum of corner points in the first interval [Lᵢ, V) and the second interval [V, Lᵢ₊₁) of the preceding frame image does not exceed a preset sorting threshold, determining that the histogram parameters of the current frame image is identical to those of the preceding frame image.

In another implementation, the Parameter Determination Module 301 is configured to: in response to determining that: (i) the sum of corner points in the first interval [Lᵢ, V) and the second interval [V, Lᵢ₊₁) of the preceding frame image exceeds the preset sorting threshold, and (ii) the left endpoint of the highest-frequency group in the preceding frame image histogram exceeds its second endpoint, then: determine the first endpoint (L1) in the histogram of the current frame image based on: (i) the left endpoint of the highest-frequency group in the preceding frame's histogram; and (ii) the group interval between the first and second endpoints in the preceding frame's histogram; determine the second endpoint (L2) in the histogram of the current frame image based on: (i) the first endpoint in the histogram of the preceding frame image; and (ii) the group interval between the first and second endpoints in the histogram of the preceding frame image; and determine the group interval between the first and second endpoints in the histogram of the current frame image based on the first and second endpoints in the histogram of the current frame image. The score of corner points of the second endpoint is greater than that of the first endpoint.

In some implementations, Parameter Determination Module 301 is configured to: in response to determining that: (i) the sum of corner points in the first interval and the second interval of the preceding frame image exceeds a preset sorting threshold, and the right endpoint of the highest-frequency group in the histogram of the preceding frame image does not exceed its first endpoint, then: determine the first endpoint in the histogram of the current frame image based on: (i) the first endpoint in the histogram of the preceding frame image, and (ii) the group interval between the first and second endpoints in the histogram of the preceding frame image; determine the group interval between the first and second endpoints in the histogram of the current frame image based on the group interval between the first and second endpoints in the histogram of the preceding frame image; and determine the second endpoint in the histogram of the current frame image based on: (i) the first endpoint in the histogram of the current frame image, and (ii) the group interval between the first and second endpoints in the histogram of the current frame image. The score of the corner point at the second endpoint is greater than the score of the corner point at the first endpoint.

In some implementations, Parameter Determination Module 301 is configured to: in response to determining that: (i) the sum of the number of corner points in the first interval and the second interval of the preceding frame image exceeds a preset sorting threshold, (ii) the left endpoint of the highest-frequency group in the histogram of the preceding frame image does not exceed its second endpoint, and (iii) the right endpoint of the highest-frequency group in the histogram of the preceding frame image exceeds its first endpoint, then: determining the histogram parameters of the current frame image as identical to those of the preceding frame image. The score of the corner point at the second endpoint is greater than that of at the first endpoint.

In some implementations, Prediction Module 302 is configured to: predict the score of the critical corner point based on: (i) the endpoints of the critical group where the critical corner point is located, (ii) the number of target corner points, (iii) the cumulative frequency of the target groups; and (iv) the sum of the cumulative frequency of the critical group where the critical corner point is located and that of the target groups. Groups positioned to the left of the group where the target corner point is located are defined as the target groups.

In some implementations, the target corner points are defined as corner points to be screened out. Screening Module 303 is configured to: (a) in response to the sum of the cumulative frequency of the groups positioned to the left of the critical group (i.e., the target groups) and the number of corner points in the first interval exceeds the number of corner points to be screened out, sort the corner points in the first interval in ascending order of their scores; determine a first number of corner points sorted from the first interval; and determine all corner points in the target groups and the first number of corner points sorted from the first interval as corner points to be screened out. The first number equals to the difference between: (i) the number of corner points to be screened out, and (ii) the cumulative frequency of the target groups.

Screening Module 303 is further configured to: (b) in response to determining that the sum of: (i) the cumulative frequency of the target groups, and (ii) the number of corner points in the first interval, equals the number of corner points to be screened out, determine all corner points in the target groups and the first interval as corner points to be screened out.

Screening Module 303 is further configured to: (c) in response to determining that the sum of: (i) the cumulative frequency of the target groups, and (ii) the number of corner points in the first interval, is larger than the number of corner points to be screened out, sort the corner points in the second interval in ascending order of their scores, determine a second number of corner points sorted from the second interval, and determine corner points of the target groups, corner points of the first interval, and the second number of corner points sorted from the second interval, as corner points to be screened out. The second number is defined as the total number of corner points to be screened out minus the sum of: (i) the number of corner points in the first interval, and (ii) the cumulative frequency of the target groups. Groups positioned to the left of the group where the target corner point is located are determined as the target groups.

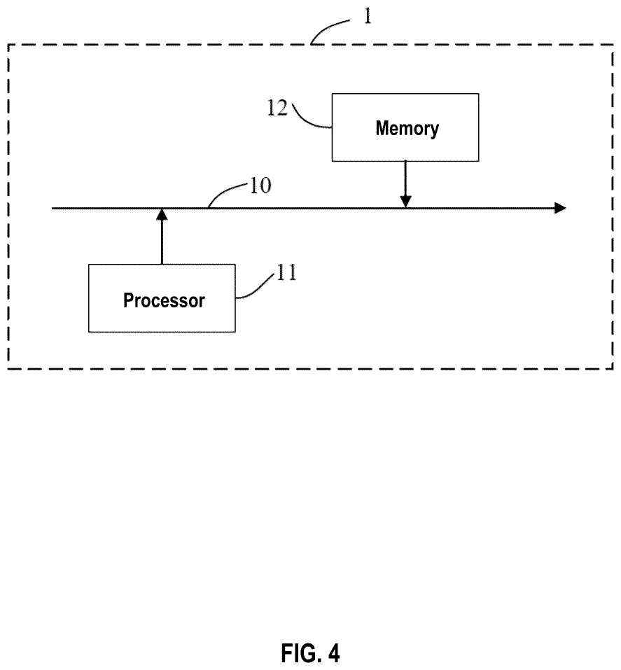

As shown in FIG. 4, the present disclosure can provide an electronic device 1 (e.g., a histogram-based corner screening device according to some implementations of the present application), including at least one processor 11 and a memory 12. In FIG. 4, a single processor 11 is shown as an example. The processor 11 and memory 12 are connected via bus 10. Memory 12 stores instructions that can be executed by processor 11. The instructions are executed by processor 11 to enable electronic device 1 to perform some or all of the processes described in the implementations below.

In some implementations, electronic device 1 can be a host, smartphone, tablet, server, server cluster, or cloud computing center used to execute the histogram-based corner screening method according to some implementations of the present application. The following description focuses on the electronic device as the executing entity.

Memory 12 can be implemented using any type of volatile or non-volatile storage devices or combinations thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic storage, flash memory, hard disks, or optical disks.

The present disclosure further provides a non-transitory computer-readable storage medium that stores computer programs. The computer program can be executed by processor 11 to perform the histogram-based corner screening method according to some implementations of the present application.

The specific implementation processes and functions of each module in the above disclosed device are detailed in the corresponding operations of the histogram-based corner screening method described above, thus, are not repeated here.

In some implementations provided in the present disclosure, the disclosed devices and methods can also be implemented through other means. The device implementations described above are illustrative. For example, the flowcharts and diagrams in the figures depict possible architectures, functionalities, and operations of devices, methods, and computer program products according to multiple implementations of the present disclosure. In this regard, each box in the flowchart or diagram may represent a part of a module, a program segment, or a piece of code, which can include one or more executable instructions for implementing specified logical functions.

In some alternative implementations, the functionalities or operations identified by the boxes shown in the figures may be performed out of the order shown in the figures. For example, two consecutive boxes may be performed substantially in parallel, or may be performed in a reverse order, depending on the functionality involved. Also, it should be noted that each box in the flowchart and/or diagram, and combinations of boxes in the flowchart and/or diagram, can be implemented by specialized hardware systems that perform the specified functions or operations, or by a combination of specialized hardware and computer instructions.

Furthermore, the functional modules in various implementations of the present disclosure can be integrated to form an independent entity, or can exist separately, or can be grouped and integrated to form multiple independent entities.

In some implementations, some functionalities can be implemented in the form of software functional modules and sold or used as standalone products. Such software functional modules can be stored in a computer-readable storage medium. Based on this understanding, the essential parts of the technical solution of the present disclosure, or parts of this technical solution, can be embodied in the form of a computer software product. The computer software product can be stored in a storage medium and includes several instructions for causing a computer device (e.g., a personal computer, a server, a network device, etc.) to perform all or part of the operations of the methods in various implementations of the present disclosure. The storage medium may include various media capable of storing program code, such as USB drives, portable hard drives, ROM, RAM, disks, or optical discs, among others.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described exemplary implementations, but should be defined only in accordance with the following claims and their equivalents.

What is claimed is:

1. A method for histogram-based corner point screening, comprising:
in response to a number of corner points in a current frame image exceeding a preset quantity threshold, determining histogram parameters of the current frame image based on:
(i) endpoints of groups in a histogram of a preceding frame image, wherein the groups are ranked in descending order of frequency up to a predefined rank, and
(ii) histogram parameters of the preceding frame image,
determining endpoints and frequencies of the groups in a histogram of the current frame image;
determining a number of target corner points, wherein the target corner points are either corner points to be screened out or retained corner points;
determining a critical group where a critical corner point is located, wherein the critical corner point is either a highest-scoring corner point among those to be screened out or a lowest-scoring corner point among those retained;
predicting a score of the critical corner point based on endpoints of the critical group where the critical corner point is located,
wherein the score of the critical corner point defines a first interval and a second interval; and
determining the target corner points based on:
(i) the number of the target corner points,
(ii) the number of corner points in the first interval, and
(iii) the number of corner points in the second interval.

2. The method according to claim 1, wherein:
the histogram parameters of the preceding frame image comprise: a first endpoint, a second endpoint, and a group interval between endpoints within an interval defined by the first endpoint and the second endpoint;
the group interval between the endpoints within the interval defined by the first endpoint and the second endpoint is smaller than the group interval between the endpoints outside the interval defined by the first endpoint and the second endpoint; and
the interval defined by the first endpoint and the second endpoint overlaps with an interval defined by the groups ranked above the predefined rank.

3. The method according to claim 1, wherein:
determining the endpoints and the frequencies of the groups in the histogram of the current frame image is based on preset scores of corner points in the current frame image and the histogram parameters of the current frame image;
determining the number of the target corner points is based on the number of corner points in the current frame image and the preset quantity threshold; and
determining the critical group where the critical corner point is located is based on the number of the target corner points and the frequencies of the groups.

4. The method according to claim 1, wherein determining the histogram parameters of the current frame image based on (i) endpoints of groups in the histogram of the preceding frame image, wherein the groups are ranked in descending order of frequency up to the predefined rank, and (ii) the histogram parameters of the preceding frame image, further comprises:
in response to determining that a sum of a number of corner points in the first interval and the second interval of the preceding frame image does not exceed a preset sorting threshold, determining that the histogram parameters of the current frame image as identical to those of the preceding frame image.

5. The method according to claim 2, wherein determining the histogram parameters of the current frame image based on: (i) endpoints of groups in the histogram of the preceding frame image, wherein the groups are ranked in descending order of frequency up to the predefined rank, and (ii) the histogram parameters of the preceding frame image, further comprises:
in response to determining that:
(i) a sum of corner points in the first interval and the second interval of the preceding frame image exceeds a preset sorting threshold, and
(ii) a left endpoint of a highest-frequency group in the histogram of the preceding frame image is greater than its second endpoint, then:
determining a first endpoint in the histogram of the current frame image based on:
(i) the left endpoint of the highest-frequency group in the histogram of the preceding frame image; and
(ii) the group interval between endpoints within the interval defined by the first endpoint and the second endpoint in the histogram of the preceding frame image;
determining a second endpoint in the histogram of the current frame image based on:
(i) the first endpoint in the histogram of the preceding frame image; and
(ii) the group interval between endpoints within the interval defined by the first endpoint and the second endpoint in the histogram of the preceding frame image; and
determining the group interval between endpoints within the interval defined by the first endpoint and the second endpoint in the histogram of the current frame image based on the first endpoint and the second endpoint in the histogram of the current frame image,
wherein the score of the corner point at the second endpoint is greater than the score of the corner point at the first endpoint.

6. The method according to claim 5, wherein determining the histogram parameters of the current frame image based on: (i) endpoints of groups in the histogram of the preceding frame image, wherein the groups are ranked in descending order of frequency up to the predefined rank, and (ii) the histogram parameters of the preceding frame image, further comprises:
in response to determining that:
(i) a sum of corner points in the first interval and the second interval of the preceding frame image exceeds a preset sorting threshold, and
(ii) a right endpoint of a highest-frequency group in the histogram of the preceding frame image does not exceed its first endpoint, then:
determining the first endpoint in the histogram of the current frame image based on: the first endpoint in the histogram of the preceding frame image; and the group interval between the first endpoint and the second endpoint in the histogram of the preceding frame image;
determining the group interval between the first endpoint and the second endpoint in the histogram of the current frame image based on the group interval between the first endpoint and the second endpoint in the histogram of the preceding frame image; and
determining the second endpoint in the histogram of the current frame image based on: the first endpoint in the histogram of the current frame image and the group interval between the first endpoint and the second endpoint in the histogram of the current frame image,
wherein the score of the corner point at the second endpoint is greater than the score at the first endpoint.

7. The method according to claim 6, wherein determining the histogram parameters of the current frame image based on: (i) endpoints of groups in the histogram of the preceding frame image, wherein the groups are ranked in descending order of frequency up to the predefined rank, and (ii) the histogram parameters of the preceding frame image, further comprises:
in response to determining that:
(i) a sum of corner points in the first interval and the second interval of the preceding frame image exceeds a preset sorting threshold,
(ii) a left endpoint of a highest-frequency group in the histogram of the preceding frame image does not exceed its second endpoint, and
(iii) a right endpoint of the highest-frequency group in the histogram of the preceding frame image exceeds its first endpoint, then:
determining that the histogram parameters of the current frame image is identical to those of the preceding frame image,
wherein the score of the corner point at the second endpoint is greater than the score of the corner point at the first endpoint.

8. The method according to claim 1, wherein predicting the score of the critical corner point comprises:
predicting the score based on:
(i) the endpoints of the critical group,
(ii) the number of the target corner points,
(iii) a cumulative frequency of target groups, and
(iv) a sum of the cumulative frequency of the critical group where the critical corner point is located and that of the target groups,
wherein the target groups are groups positioned to a left of the group containing the target corner point.

9. The method according to claim 1, wherein the target corner points are defined as corner points to be screened out, and determining the target corner points based on: (i) the number of the target corner points, (ii) the number of corner points in the first interval, and (iii) the number of corner points in the second interval, further comprises:
(a) in response to a sum of a cumulative frequency of target groups and a number of corner points in the first interval exceeds the number of corner points to be screened out,
(i) sorting the corner points in the first interval in descending order of their scores,
(ii) determining a first number of corner points sorted from the first interval, and
(iii) determining all corner points in the target groups and the first number of corner points sorted from the first interval as corner points to be screened out,
wherein the first number is defined as a numerical difference between (i) the number of corner points to be screened out; and (ii) the cumulative frequency of the target groups;
(b) in response to determining that the sum of: (i) the cumulative frequency of the target groups; and (ii) the number of corner points in the first interval, equals the number of corner points to be screened out,
determining all corner points in the target groups and all corner points in the first interval as corner points to be screened out; and
(c) in response to determining that the sum of: (i) the cumulative frequency of the target groups; and (ii) the number of corner points in the first interval, exceeds the number of corner points to be screened out,
sorting the corner points in the second interval in ascending order of their scores,
determining a second number of corner points sorted from the second interval, and
determining all corner points in the target groups, all the corner points in the first interval, and the second number of corner points sorted from the second interval as corner points to be screened out,
wherein the second number is defined as a numerical difference between: (i) the number of corner points to be screened out; and (ii) the sum of: the number of corner points in the first interval, and the cumulative frequency of the target groups, and
wherein groups positioned to a left of the target group where the target corner points are located are defined as the target groups.

10. An electronic device, comprising:
a memory storing one or more programs; and
a processor coupled to the memory and configured to execute the one or more programs, wherein when the one or more programs are executed by the processor, cause the processor to perform a histogram-based corner point screening method comprising:
in response to a number of corner points in a current frame image exceeding a preset quantity threshold, determining histogram parameters of the current frame image based on:
(i) endpoints of groups in a histogram of a preceding frame image, wherein the groups are ranked in descending order of frequency up to a predefined rank, and
(ii) histogram parameters of the preceding frame image,
determining endpoints and frequencies of the groups in the histogram of the current frame image;
determining a number of target corner points, wherein the target corner points are either corner points to be screened out or retained corner points;
determining a critical group where a critical corner point is located, wherein the critical corner point is either a highest-scoring corner point among those to be screened out or a lowest-scoring corner point among those retained;
predicting a score of the critical corner point based on endpoints of the critical group where the critical corner point is located,
wherein the score of the critical corner point defines a first interval and a second interval; and
determining the target corner points based on:
(i) the number of the target corner points,
(ii) the number of corner points in the first interval, and
(iii) the number of corner points in the second interval.

11. The electronic device according to claim 10, wherein:
the histogram parameters of the preceding frame image comprise: a first endpoint, a second endpoint, and a group interval between endpoints within an interval defined by the first endpoint and the second endpoint;
the group interval between the endpoints within the interval defined by the first endpoint and the second endpoint is smaller than the group interval between the endpoints outside the interval defined by the first endpoint and the second endpoint; and
the interval defined by the first endpoint and the second endpoint overlaps with an interval defined by the groups ranked above the predefined rank.

12. The electronic device according to claim 10, wherein:
determining the endpoints and the frequencies of the groups in the histogram of the current frame image is based on preset scores of corner points in the current frame image and the histogram parameters of the current frame image;
determining the number of the target corner points is based on the number of corner points in the current frame image and the preset quantity threshold; and
determining the critical group where the critical corner point is located is based on the number of the target corner points and the frequencies of the groups.

13. The electronic device according to claim 10, wherein determining the histogram parameters of the current frame image based on (i) endpoints of groups in the histogram of the preceding frame image, wherein the groups are ranked in descending order of frequency up to the predefined rank, and (ii) the histogram parameters of the preceding frame image, further comprises:
in response to determining that a sum of a number of corner points in the first interval and the second interval of the preceding frame image does not exceed a preset sorting threshold, determining that the histogram parameters of the current frame image as identical to those of the preceding frame image.

14. The electronic device according to claim 11, wherein determining the histogram parameters of the current frame image based on: (i) endpoints of groups in the histogram of the preceding frame image, wherein the groups are ranked in descending order of frequency up to the predefined rank, and (ii) the histogram parameters of the preceding frame image, further comprises:
in response to determining that:
(i) a sum of corner points in the first interval and the second interval of the preceding frame image exceeds a preset sorting threshold, and
(ii) a left endpoint of a highest-frequency group in the histogram of the preceding frame image is greater than its second endpoint, then:
determining a first endpoint in the histogram of the current frame image based on:
(i) the left endpoint of the highest-frequency group in the histogram of the preceding frame image; and
(ii) the group interval between endpoints within the interval defined by the first endpoint and the second endpoint in the histogram of the preceding frame image;
determining a second endpoint in the histogram of the current frame image based on:
(i) the first endpoint in the histogram of the preceding frame image; and
(ii) the group interval between endpoints within the interval defined by the first endpoint and the second endpoint in the histogram of the preceding frame image; and
determining the group interval between endpoints within the interval defined by the first endpoint and the second endpoint in the histogram of the current frame image based on the first endpoint and the second endpoint in the histogram of the current frame image,
wherein the score of the corner point at the second endpoint is greater than the score of the corner point at the first endpoint.

15. The electronic device according to claim 14, wherein determining the histogram parameters of the current frame image based on: (i) endpoints of groups in the histogram of the preceding frame image, wherein the groups are ranked in descending order of frequency up to the predefined rank, and (ii) the histogram parameters of the preceding frame image, further comprises:
in response to determining that:
(i) a sum of corner points in the first interval and the second interval of the preceding frame image exceeds a preset sorting threshold, and
(ii) a right endpoint of a highest-frequency group in the histogram of the preceding frame image does not exceed its first endpoint, then:
determining the first endpoint in the histogram of the current frame image based on: the first endpoint in the histogram of the preceding frame image; and the group interval between the first endpoint and the second endpoint in the histogram of the preceding frame image;
determining the group interval between the first endpoint and the second endpoint in the histogram of the current frame image based on the group interval between the first endpoint and the second endpoint in the histogram of the preceding frame image; and
determining the second endpoint in the histogram of the current frame image based on: the first endpoint in the histogram of the current frame image and the group interval between the first endpoint and the second endpoint in the histogram of the current frame image,
wherein the score of the corner point at the second endpoint is greater than the score at the first endpoint.

16. The electronic device according to claim 15, wherein determining the histogram parameters of the current frame image based on: (i) endpoints of groups in the histogram of the preceding frame image, wherein the groups are ranked in descending order of frequency up to the predefined rank, and (ii) the histogram parameters of the preceding frame image, further comprises:
in response to determining that:
(i) a sum of corner points in the first interval and the second interval of the preceding frame image exceeds a preset sorting threshold,
(ii) a left endpoint of a highest-frequency group in the histogram of the preceding frame image does not exceed its second endpoint, and
(iii) a right endpoint of the highest-frequency group in the histogram of the preceding frame image exceeds its first endpoint, then:
determining that the histogram parameters of the current frame image is identical to those of the preceding frame image,
wherein the score of the corner point at the second endpoint is greater than the score of the corner point at the first endpoint.

17. The electronic device according to claim 10, wherein predicting the score of the critical corner point comprises:
predicting the score based on:
(i) the endpoints of the critical group,
(ii) the number of the target corner points,
(iii) a cumulative frequency of target groups, and
(iv) a sum of the cumulative frequency of the critical group where the critical corner point is located and that of the target groups,
wherein the target groups are groups positioned to a left of the group containing the target corner point.

18. The electronic device according to claim 10, wherein the target corner points are defined as corner points to be screened out, and determining the target corner points based on: (i) the number of the target corner points, (ii) the number of corner points in the first interval, and (iii) the number of corner points in the second interval, further comprises:
(a) in response to a sum of a cumulative frequency of target groups and a number of corner points in the first interval exceeds the number of corner points to be screened out,
(i) sorting the corner points in the first interval in descending order of their scores,
(ii) determining a first number of corner points sorted from the first interval, and
(iii) determining all corner points in the target groups and the first number of corner points sorted from the first interval as corner points to be screened out,
wherein the first number is defined as a numerical difference between (i) the number of corner points to be screened out; and (ii) the cumulative frequency of the target groups;
(b) in response to determining that the sum of: (i) the cumulative frequency of the target groups; and (ii) the number of corner points in the first interval, equals the number of corner points to be screened out,
determining all corner points in the target groups and all corner points in the first interval as corner points to be screened out; and
(c) in response to determining that the sum of: (i) the cumulative frequency of the target groups; and (ii) the number of corner points in the first interval, exceeds the number of corner points to be screened out,
sorting the corner points in the second interval in ascending order of their scores,
determining a second number of corner points sorted from the second interval, and
determining all corner points in the target groups, all the corner points in the first interval, and the second number of corner points sorted from the second interval as corner points to be screened out,
wherein the second number is defined as a numerical difference between: (i) the number of corner points to be screened out; and (ii) the sum of: the number of corner points in the first interval, and the cumulative frequency of the target groups, and
wherein groups positioned to a left of the target group where the target corner points are located are defined as the target groups.

19. A non-transitory computer-readable medium storing instructions that, when executed by a processor, cause the processor to perform a histogram-based corner point screening method comprising:
in response to a number of corner points in a current frame image exceeding a preset quantity threshold, determining histogram parameters of the current frame image based on:
(i) endpoints of groups in a histogram of a preceding frame image, wherein the groups are ranked in descending order of frequency up to a predefined rank, and
(ii) histogram parameters of the preceding frame image,
determining endpoints and frequencies of the groups in the histogram of the current frame image;
determining a number of target corner points, wherein the target corner points are either corner points to be screened out or retained corner points;
determining a critical group where a critical corner point is located, wherein the critical corner point is either a highest-scoring corner point among those to be screened out or a lowest-scoring corner point among those retained;
predicting a score of the critical corner point based on endpoints of the critical group where the critical corner point is located,
wherein the score of the critical corner point defines a first interval and a second interval; and
determining the target corner points based on:
(i) the number of the target corner points,
(ii) the number of corner points in the first interval, and
(iii) the number of corner points in the second interval.

20. The non-transitory computer-readable medium according to claim 19, wherein:
the histogram parameters of the preceding frame image comprise: a first endpoint, a second endpoint, and a group interval between endpoints within an interval defined by the first endpoint and the second endpoint;
the group interval between the endpoints within the interval defined by the first endpoint and the second endpoint is smaller than the group interval between the endpoints outside the interval defined by the first endpoint and the second endpoint; and
the interval defined by the first endpoint and the second endpoint overlaps with an interval defined by the groups ranked above the predefined rank.
